(19) United States
(12) Patent Application Publication
(10) Pub. No.: US 2011/0181843 A1
(43) Pub. Date: Jul. 28, 2011

(54) PROJECTION DISPLAY DEVICE

(75) Inventors: Yuji HASHIBA, Osaka (JP); Yusuke YAMAMOTO, Osaka (JP); Toshihiro SARUWATARI, Osaka (JP)

(73) Assignee: SANYO ELECTRIC CO., LTD., Osaka (JP)

(21) Appl. No.: 13/014,139

(22) Filed: Jan. 26, 2011

(30) Foreign Application Priority Data
Jan. 26, 2010 (JP) 2010-014823

(51) Int. Cl. G03B 21/16

(52) U.S. Cl. 353/52

(57) ABSTRACT

A projection display device includes an imager portion which modulates light based on an image signal; a projection lens unit which includes a resin lens and projects the light modulated by the imager portion; a projection port which is formed in a main body cabinet, and passes light from the projection lens unit; an air inlet which is formed in a vicinity of the projection port of the main body cabinet; and an air passing portion which draws in an air through the air inlet and passes the drawn-in air along the projection lens unit.

This application claims priority under 35 U.S.C. Section 119 of Japanese Patent Application No. 2010-14823 filed Jan. 26, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for enlarging and projecting light modulated by an imager onto a projection plane.

2. Disclosure of Related Art

In a projection display device (hereinafter, called as a “projector”), light modulated by an imager such as a liquid crystal panel is projected onto a projection plane by a projection lens unit. In the projector, heat is generated in a power source unit or a light source. In view of this, the projector is provided with an arrangement for releasing the heat generated in the projector to the outside of the projector.

In the above arrangement, if a high-temperature exhaust air is blown over projected light, a projected image may be fluctuated. In view of this, it is necessary to dispose or arrange an air outlet at such a position that an exhaust air is not blown onto projected light in releasing the heat.

Conventionally, a projection lens unit mainly includes a glass lens. Accordingly, characteristic deterioration of the projection lens unit resulting from heat has not been a serious problem.

In recent years, however, a resin lens has been used as a lens constituting a projection lens unit to reduce the cost. In this case, characteristic deterioration of the projection lens unit such as thermal expansion may be a problem.

Particularly, in recent years, needs for obtaining a high-luminance projected image have been increased, and development of a high-luminance light source has been progressed, as the needs have been increased. Characteristic deterioration of a resin lens becomes conspicuous, as development of a high-luminance light source has been progressed. In view of this, it is necessary to provide an arrangement for cooling a projection lens unit in using a resin lens.

### SUMMARY OF THE INVENTION

A projection display device according to a main aspect of the invention includes an imager portion which modulates light based on an image signal; a projection lens unit which includes a resin lens and projects the light modulated by the imager portion; a projection port which is formed in a main body cabinet, and passes light from the projection lens unit; an air inlet which is formed in a vicinity of the projection port of the main body cabinet; and an air passing portion which draws in an air through the air inlet and passes the drawn-in air along the projection lens unit.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an arrangement of a projector embodying the invention.

FIG. 2 is a diagram showing arrangements of an optical engine and a projection lens unit in the embodiment.

FIGS. 3A and 3B are perspective views of the projector in the embodiment showing a state that an upper cabinet, a control circuit unit, and a projection lens unit are detached.

FIGS. 4A and 4B are diagrams for describing arrangements of a lens holder and an air inlet cover in the embodiment.

FIG. 5 is a diagram for describing a flow of an external air drawn into a main body cabinet through an air inlet in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, a lower cabinet 11 and an upper cabinet 12 correspond to a main body cabinet in the claims. An optical engine 20 corresponds to an imager portion in the claims. An exhaust fan unit 80, a first exhaust fan 801, and an exhaust air passage EW correspond to an air passing portion in the claims. A lens holder 90 corresponds to a holder in the claims. Hook members 134 and 135, and holding members 136 and 137 correspond to a concealing member in the claims. The description regarding the correspondence between the claims and the embodiment is merely an example, and the claims are not limited by the description of the embodiment.

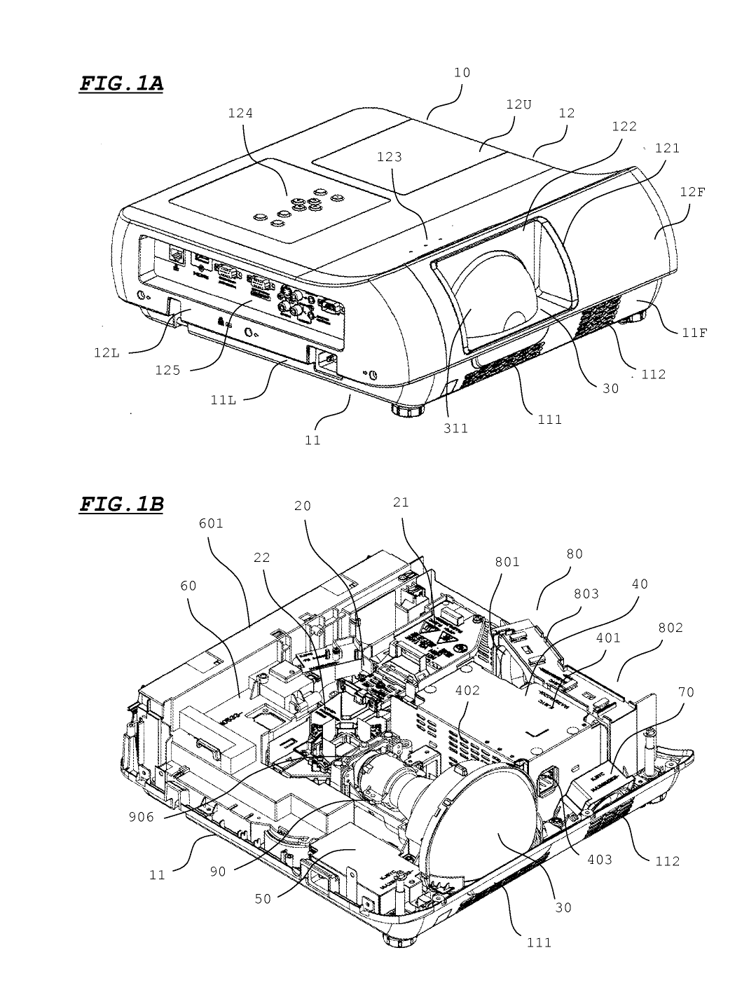

FIGS. 1A and 1B are perspective views showing an arrangement of a projector. FIG. 1A is an external perspective view of the projector, and FIG. 1B is a perspective view of the projector showing a state that an upper cabinet 12 and a control circuit unit are detached.

Referring to FIGS. 1A and 1B, the projector is provided with a main body cabinet 10. The main body cabinet 10 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 11B. The left side surface 11L and the right side surface 11R are configured in such a manner that front ends thereof gradually rise, and are continued to the front surface 11F.

The front surface 11F of the lower cabinet 11 is formed with an air inlet 111. The air inlet 111 is formed in the main body cabinet 10 at a position below a projection port 121 for a projection lens unit 30, and lower than the projection lens unit 30. The front surface 11F of the lower cabinet 11 is further formed with a sound output port 112. Sounds in accordance with images are outputted through the sound output port 112 at the time of image projection.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a lateral direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 30 is formed at a rear position of the projection port 121.

An upper surface 12U of the upper cabinet 12 is formed with an indicator portion 123 and an operation portion 124. A certain number of LEDs are provided on the indicator portion 123. The user is allowed to confirm whether the projector is in an operating state or a standby state by on/off states of the respective LEDs. The user is also allowed to confirm various error states. A certain number of operation keys are provided on the operation portion 124.

An AV terminal portion 125 is provided on the left side surface 12L of the upper cabinet 12, and various AV terminals are exposed on the left side surface 12L of the upper cabinet 12. AV (Audio Visual) signals are inputted and outputted to and from the projector via the AV terminal portion 125.

As shown in FIG. 1B, the lower cabinet 11 is internally provided with an optical engine 20, the projection lens unit 30, a main power source unit 40, a sub power source unit 50, a cooling unit 60, a speaker 70, and an exhaust fan unit 80. Although other members such as a control circuit unit are disposed in the lower cabinet 11, illustration thereof is omitted in FIG. 1B.

The optical engine 20 is provided with a light source portion 21 having a light source lamp, and an optical system 22 for modulating light from the light source portion 21 to generate image light. The optical engine 20 is disposed slightly rearward with respect to the center of the lower cabinet 11. The projection lens unit 30 is disposed in front of the optical system 22 of the optical engine 20, and slightly leftward with respect to the center of the lower cabinet 11. The projection lens unit 30 is fixed to the lower cabinet 11 via a lens holder 31.

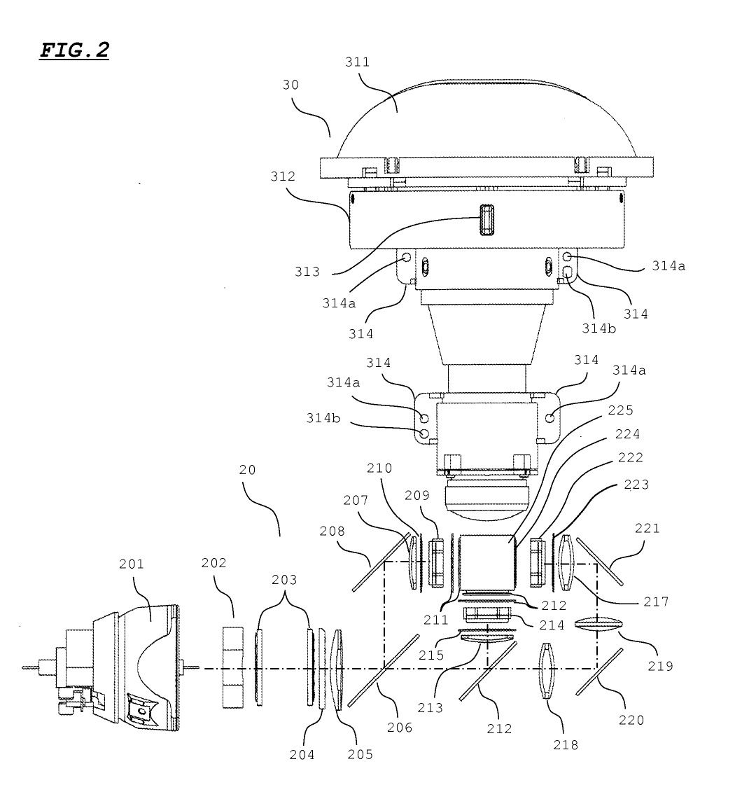

FIG. 2 is a diagram showing an arrangement of the optical engine 20 and the projection lens unit 30.

White light emitted from the light source lamp 201 is transmitted through a condenser lens 202, a fly-eye integrator 203, and a PBS array 204. The fly-eye integrator 203 is adapted to make the light amount distributions of light of the each of the colors to be irradiated onto liquid crystal panels (which will be described later) uniform, and the PBS array 204 is adapted to align polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 214 for G light in a proper irradiation state by a lens function of the condenser lens 205 and a condenser lens 213. The liquid crystal panel 214 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 30 from the dichroic prism 225.

The projection lens unit 30 is adapted to enlarge and project the entered image light onto a screen. The projection lens unit 30 is configured as a short focal length type, and a large sized lens 311 is included at a front end of the projection lens unit 30. Image light is emitted slightly obliquely upward from the lens 311. The projection lens unit 30 is provided with plural lenses, in addition to the lens 311. The lenses of the projection lens unit 30 include a plastic lens. The lens 311 has a circular shape with a lower part thereof being cut away, when viewed from the front side of the lens 311.

The projection lens unit 30 is further provided with a focus ring 312. The focus ring 312 is formed with a focus lever 313. When the focus lever 313 is operated, the focus ring 312 is pivotally moved, and a focus lens (not shown) disposed in the projection lens unit 30 is moved in association with the focus ring 312. Thus, by operating the focus lever 313, focus for a projected image is adjusted.

The projection lens unit 30 is further formed with four attachment portions 314. Each of the attachment portions 314 is formed with a threaded hole 314a for attaching the projection lens unit 30 to a lens holder 90 by screws. Further, one of the front-side attachment portions 314, and one of the rear-side attachment portions 314 at a diagonal position with respect to the one of the front-side attachment portions 314 are formed with a positioning hole 314b in which a positioning projection (to be described later) of the lens holder 90 is inserted.

Referring back to FIGS. 1A and 1B, the main power source unit 40 is disposed on the right side of the projection lens unit 30, and the sub power source unit 50 is disposed on the left side of the projection lens unit 30. The main power source unit 40 is provided with a power source circuit within a housing 401, and is adapted to supply an electric power to the respective electrical components of the projector. The housing 401 is formed with a vent 402 constituted of multitudes of holes on a side surface thereof on the side of the projection lens unit 30. Another vent (not shown) is formed on the opposite side surface of the housing 401.

The sub power source unit 50 is provided with a noise filter and a smoothing circuit, and is adapted to remove noises from an AC power provided from a commercial power source. The sub power source unit 50 supplies the noise removed AC power to the main power source unit 40.

The cooling unit 60 is disposed behind the optical engine 20. The cooling unit 60 is provided with an air intake fan (not shown). An air inlet portion 601 of the cooling unit 60 is formed at a rear end of the lower cabinet 11. The cooling unit 60 supplies the external air drawn in through the air inlet portion 601 from the rear side of the main body cabinet 10 to the main heat generating parts of the optical engine 20 such as the liquid crystal panels 209, 214, and 222 to thereby cool the heat generating parts.

The speaker 70 is disposed in front of the main power source unit 40. Sounds outputted from the speaker 70 are released to the outside through the sound output port 112.

The exhaust fan unit 80 is disposed on the right side of the main power source unit 40, and at a right side end of the lower cabinet 11. The exhaust fan unit 80 is constituted of a first exhaust fan 801, a second exhaust fan 802, and a fan holder 803 for fixedly holding the first exhaust fan 801 and the second exhaust fan 802 to the lower cabinet 11.

The first exhaust fan 801 has an air in-take surface thereof being tilted slightly obliquely rearward with respect to the left side surface of the main body cabinet 10. The first exhaust fan 801 is adapted to discharge to the outside an air that has been warmed by cooling the heat generating parts (such as the liquid crystal panels 209, 214, and 222; and the light source lamp 201) inside the optical engine 20. The first exhaust fan 801 is also adapted to discharge to the outside an air that has been drawn in through the air inlet 111 and warmed by cooling the projection lens unit 30.

The second exhaust fan 802 has an air in-take surface thereof being directed to the main power source unit 40. The second exhaust fan 802 discharges to the outside an air that has been warmed by cooling the main power source unit 40.

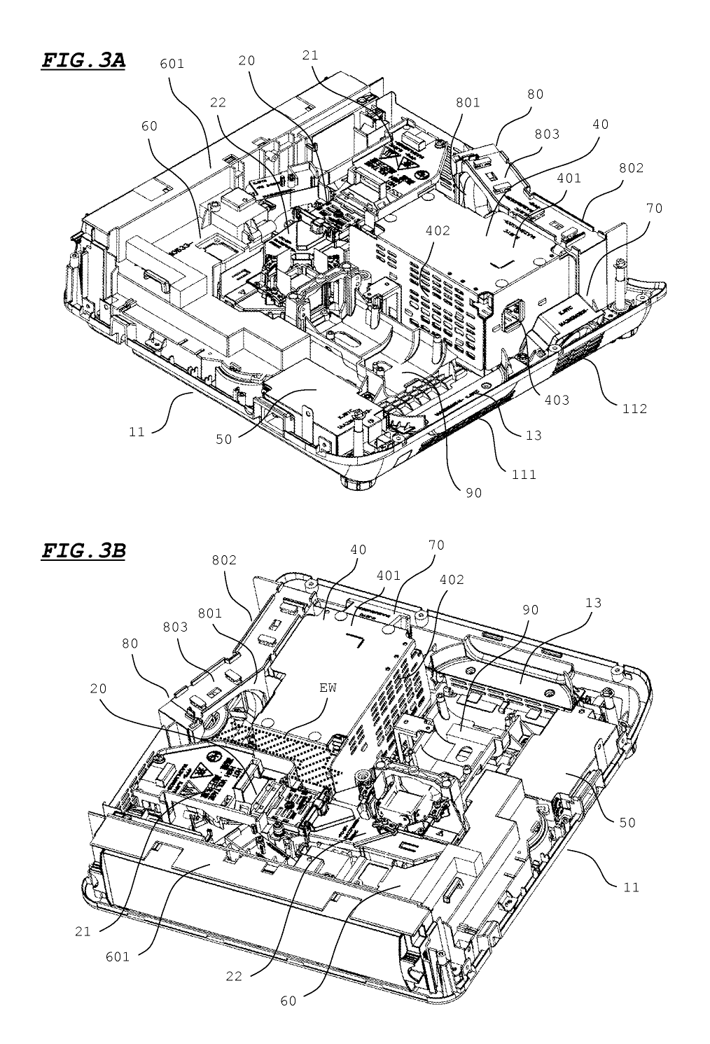

FIGS. 3A and 3B are perspective views of the projector showing a state that the upper cabinet 12, the control circuit unit, and the projection lens unit 30 are detached. FIG. 3A is a perspective view of the projector when viewed from the front side thereof, and FIG. 3B is a perspective view of the projector when viewed from the rear side thereof.

As shown in FIGS. 3A and 3B, the lower cabinet 11 is mounted with an air inlet cover 13 for covering the air inlet 111 from the inside thereof. Further, as shown by the dotted portion in FIG. 3B, an exhaust air passage EW extends from a rear end of the lens holder 90 toward the first exhaust fan 801 by increasing the clearance between the optical engine 20 and the main power source unit 40.

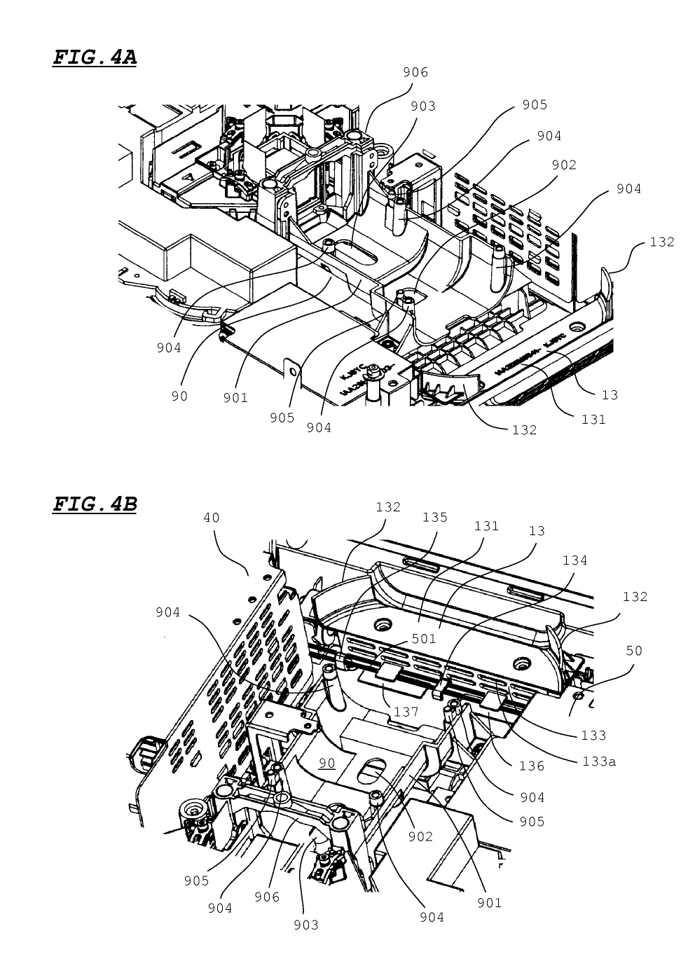

FIGS. 4A and 4B are diagrams for describing arrangements of the lens holder 90 and the air inlet cover 13. FIG. 4A is a perspective view of essential parts when viewed from the front side, and FIG. 4B is a perspective view of essential parts when viewed from the rear side.

Referring to FIGS. 4A and 4B, the lens holder 90 is provided with a holder main body 901. The holder main body 901 is made of a metal material e.g. a magnesium material, and has a concave curved shape to follow a bottom surface of the projection lens unit 30. The lens holder 90 is attached to the lower cabinet 11 in such a manner that a clearance is defined between a bottom surface of the lower cabinet 11 and the lens holder 90.

A bottom surface of the holder main body 901 is formed with two openings 902 and 903. The holder main body 901 is further formed with four attachment bosses 904 on left and right ends thereof. Positioning projections 905 are formed each behind the front left-side attachment boss 904 and the rear right-side attachment boss 904.

A frame member 906 for fixing a rear end (incident surface side) of the projection lens unit 30 is attached to a rear end of the holder main body 901.

As shown in FIG. 1B, when the projection lens unit 30 is attached to the lens holder 90, the four threaded holes 314a in the projection lens unit 30 are aligned with the corresponding attachment bosses 904. Further, the positioning projections 905 are inserted in the two positioning holes 314b. Thus, the projection lens unit 30 is fixed to the lens holder 90 by fastening the attachment portions 314 and the attachment bosses 904 by screws. Further, the rear end of the projection lens unit 30 is fixed to the frame member 906.

The air inlet cover 13 is provided with a receiving member 131 for receiving a bottom portion of a front end of the projection lens unit 30. The receiving member 131 is formed with upright plate members 132 on both sides thereof for supporting side surfaces of a bottom portion of the projection lens unit 30.

A cover member 133 facing the air inlet 111 is formed on a rear end on a lower surface of the receiving member 131. The cover member 133 is formed with multitudes of passage holes 133a. A holding portion for holding a lead wire 501 to supply an electric power from the sub power source unit 50 to the main power source unit 40 is provided at a position lower than the passage holes 133a of the cover member 133. The holding portion is constituted of two hook members 134 and 135, and two holding members 136 and 137 configured to sandwich the lead wire 501 therebetween.

As described above, since the air inlet 111 is covered by the air inlet cover 13, there is no or less likelihood that the interior of the projector may be seen through the air inlet 111. Further, the lead wire 501 is held at a position lower than the passage holes 133a, there is no or less likelihood that the lead wire 501 may be seen from the outside through the air inlet 111. Thus, the above arrangement provides an enhanced appearance.

A certain clearance is formed between the projection lens unit 30 and the holder main body 901 in a state that the projection lens unit 30 is fixed to the lens holder 90. Apart of an air that has passed through the passage holes 133a passes through the clearance to cool the projection lens unit 30. Further, a part of the air that has passed through the passage holes 133a passes through a clearance formed between the lens holder 90 and the bottom surface of the lower cabinet 11, and is guided to the projection lens unit 30 through the openings 902 and 903. In this way, the projection lens unit 30 is further cooled by the air that has passed through the openings 902 and 903.

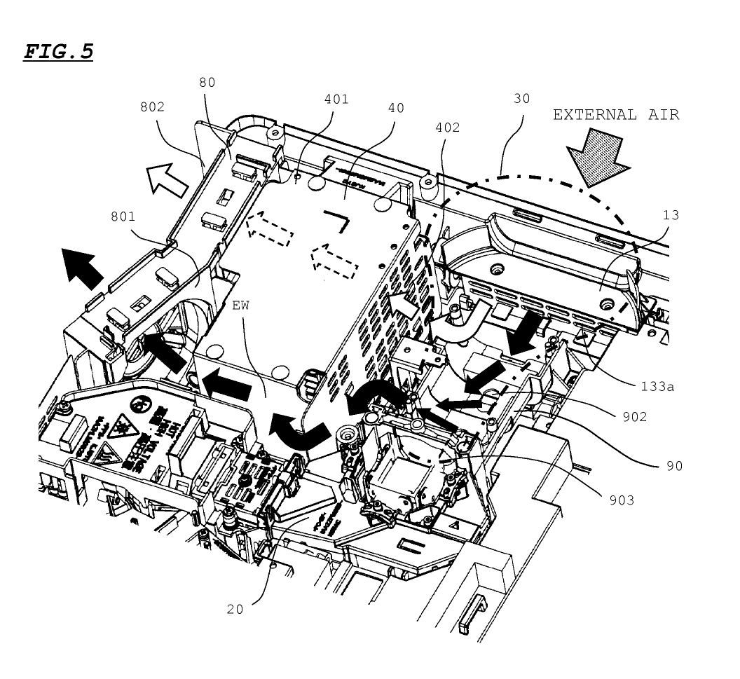

FIG. 5 is a diagram for describing a flow of an external air drawn into the main body cabinet 10 through the air inlet 111. In FIG. 5, the projection lens unit 30 is shown by the one-dotted chain line to clearly describe the flow of air.

When the exhaust fan unit 80 is driven, an external air is drawn into the main body cabinet 10 through the air inlet 111 (see FIG. 1A) and through the passage holes 133a. In the drawing operation, a part of the external air drawn in through the air inlet 111 is flowed into the housing 401 through the air inlet 402, after cooling a front portion of the projection lens unit 30 by driving of the second exhaust fan 802, and is discharged to the outside after cooling a power source circuit of the main power source unit 40 (see the hollow arrows in FIG. 5).

On the other hand, an air at the rear end of the projection lens unit 30 is drawn into the first exhaust fan 801 through the exhaust air passage EW by driving of the first exhaust fan 801. With this operation, a flow of air indicated by the black arrows in FIG. 5 is generated in the main body cabinet 10. Specifically, the external air drawn in through the air inlet 111 is flowed toward the rear end of the projection lens unit 30, and then is discharged to the outside through the exhaust air passage EW. With the flow of air, the entirety of the projection lens unit 30 including the front end and the rear end thereof is cooled.

In performing the above operation, since the openings 902 and 903 are formed in the bottom surface of the holder main body 901 of the lens holder 90, an air is also supplied to the bottom surface side of the projection lens unit 30 through the openings 902 and 903. With this operation, the projection lens unit 30 is effectively cooled.

Further, since the holder main body 901 is made of a metal, the holder main body 901 itself is easily cooled. Thus, the projection lens unit 30 is more effectively cooled by way of the cooled holder main body 901.

As described above, in this embodiment, an external air drawn in through the air inlet 111 is flowed along the projection lens unit 30, and the projection lens unit 30 is favorably cooled by the external air. With this operation, even if the projection lens unit 30 includes a plastic lens, thermal expansion of the plastic lens is suppressed. Thus, the above arrangement enables to prevent performance deterioration of the projection lens unit 30.

Further, in this embodiment, since the air is diffused and guided in the vicinity of the projection lens unit 30 through the openings 902 and 903, the entirety of the projection lens unit 30 can be effectively cooled.

Furthermore, in this embodiment, the air inlet ill is formed at a position lower than the projection lens unit 30. Accordingly, even if dusts and the like are contained in the drawn-in air, there is no or less likelihood that the dusts may adhere to the bottom surface of the lower cabinet 11, and stagnate in the projection lens unit 30.

Moreover, in this embodiment, since the air inlet 111 is covered by the air inlet cover 13, there is no or less likelihood that the interior of the projector may be seen through the air inlet 111. Further, since dusts and fumes drawn in through the air inlet 111 with the air can be removed by the passage holes 133a, it is possible to suppress intrusion of dusts and fumes.

The embodiment of the invention has been described as above. The invention, however, is not limited to the foregoing embodiment, and the embodiment of the invention may be modified in various ways other than the above.

For instance, in this embodiment, the air inlet 111 is disposed below the projection port 121. Alternatively, the air inlet 111 may be disposed at a position in the vicinity of the projection port 121 other than the above, for instance, on the left side or the right side of the projection port 121. It is, however, desirable to dispose the air inlet 111 below the projection port 121, as shown in the embodiment, considering enhancing the appearance and an influence of dusts.

Further, in this embodiment, the holder main body 901 is made of a magnesium material. Alternatively, the holder main body 901 may be made of other metal material having a large heat conductivity such as aluminium.

Furthermore, in this embodiment, a projector incorporated with the projection lens unit 30 having a short focal length is used. The present invention may be applied to a projector incorporated with a projection lens unit 30 of other type.

The openings 902 and 903 shown in FIGS. 4A and 4B may be disposed at a position corresponding to a portion of the projection lens unit 30, where cooling is particularly desired, such as the position where a resin lens is disposed.

The embodiment of the invention may be changed or modified in various ways as necessary, as far as such changes and modifications do not depart from the scope of the claims of the invention hereinafter defined.

What is claimed is:

1. A projection display device comprising:
an imager portion which modulates light based on an image signal;
a projection lens unit which includes a resin lens and projects the light modulated by the imager portion;
a projection port which is formed in a main body cabinet, and passes light from the projection lens unit;
an air inlet which is formed in a vicinity of the projection port of the main body cabinet; and
an air passing portion which draws in an air through the air inlet and passes the drawn-in air along the projection lens unit.

2. The projection display device according to claim 1, further comprising
a holder which is disposed in the main body cabinet and on which the projection lens unit is mounted, wherein
the holder is formed with an opening through which the drawn-in air through the air inlet is diffused and guided to a vicinity of the projection lens unit.

3. The projection display device according to claim 2, wherein
the holder is made of a metal material.

4. The projection display device according to claim 1, wherein
the air inlet is disposed below the projection port.

5. The projection display device according to claim 1, further comprising
an air inlet cover which is disposed on an inner side of the main body cabinet, and covers the air inlet, the air inlet cover being formed with a passage hole for passing the drawn-in air through the air inlet.

6. The projection display device according to claim 5, further comprising
a concealing member which is disposed on the air inlet cover to conceal a wire passing through an interior of the projection display device from being seen through the passage hole and the air inlet.
